(19) United States
(12) Patent Application Publication
(10) Pub. No.: US 2018/0148083 A1
(43) Pub. Date: May 31, 2018

(54) VEHICLE STEERING DEVICE

(71) Applicant: HONDA MOTOR CO., LTD., Tokyo (JP)

(72) Inventor: Toshikatsu Kuramochi, Tokyo (JP)

(21) Appl. No.: 15/822,382

(22) Filed: Nov. 27, 2017

(30) Foreign Application Priority Data
Nov. 28, 2016 (JP) 2016-229869

(51) Int. Cl. B62D 1/12; B60R 16/00; B60Q 1/34

(52) U.S. Cl. CPC B62D 1/12; B60Q 1/343; B60R 16/005

(57) ABSTRACT

A vehicle steering device in which turn signal switches are disposed along axial directions of grip members of left and right steering units. While the grip members are being operated in opposite forward and rearward directions when turning to the right or left, the turn signal switches are also operated in opposite axial directions upon turning to the right or left or the like, and therefore, are easily matched with the movements of the steering units. More specifically, there is continuity between the movement of the arms during turning and the movement of the fingers of the right and left turning indicators, and thus operation of the vehicle steering device is facilitated.

### CROSS-REFERENCE TO RELATED APPLICATION

This application is based upon and claims the benefit of priority from Japanese Patent Application No. 2016-229869 filed on Nov. 28, 2016, the contents of which are incorporated herein by reference.

### BACKGROUND OF THE INVENTION

### Field of the Invention

The present invention relates to a steering device for a vehicle in which steering units having columnar shaped grip members (of a prismatic shape, a cylindrical columnar shape, a semicircular columnar shape having a semicircular cross section, or the like), each of which is gripped by a left or right hand of a driver, are used as steering units (handles) for steering steered wheels of the vehicle.

### Description of the Related Art

For example, FIG. 4 of Japanese Laid-Open Patent Publication No. 2005-225384 (hereinafter referred to as JP2005-225384A) discloses a vehicle steering device equipped with left and right sticks that extend downwardly to the left and right in spoke-like shapes so as to approach toward the driver from a hub portion connected to a steering shaft, and furthermore, which extend toward a front side of the vehicle respectively from distal ends of the spoke-shaped parts (paragraphs [0022], [0023] of JP2005-225384A).

With the vehicle steering device, the steered wheels can be steered in left and right swinging directions, and the vehicle can be steered by rocking the sticks to the right and left, and for example, it is possible to reduce a sense of response delay of the vehicle with respect to steering operations performed at low driving speed (paragraphs [0024], [0026] of JP2005-225384A).

### SUMMARY OF THE INVENTION

Incidentally, at a time of turning to the right or left or changing course to steer the vehicle in a left direction or a right direction, a direction indicator is illuminated in order to indicate to the surrounding vicinity the direction of turning (a right or left turning direction or the direction of a change in course).

In order to turn on or illuminate the direction indicator, according to the vehicle steering device described in JP2005-225384A, a technique is disclosed in which buttons are provided on distal ends of the sticks that are grasped by the hands of the driver, and the buttons are operated with the thumbs to thereby turn on and illuminate the direction indicators.

However, it cannot be said that an appropriate relationship necessarily exists between the illumination of the direction indicators involving the pressing operation of the buttons by the thumbs, and steering involving the left and right swinging operations by the hands that grip the sticks, and room remains for improvement.

Stated otherwise, for example, in the operation of a direction indicator lever, or a so-called blinker lever, which is arranged to extend horizontally to the right from the column of a normal steering wheel of a right-hand steered vehicle, an upward rotation operation corresponds to a left turn, and a downward rotation operation corresponds to a right turn. In contrast thereto, in any case, operation of the buttons was found to bring about a sense of incompatibility, because the direction of the button pressing operation is in one direction only (a downward direction).

Further, for example, in the operation of a direction indicator lever, or a so-called blinker lever, which is arranged to extend horizontally to the left from the column of a steering wheel of a left-hand steered vehicle, an upward rotation operation corresponds to a right turn, and a downward rotation operation corresponds to a left turn. In contrast thereto, in this case as well, in the event that the direction of the pressing operation of the buttons is in one direction only, there is also a sense of incompatibility.

The present invention has been devised taking into consideration the aforementioned problem, and has the object of providing a vehicle steering device in which operating members for indicating a change in course or a right or left turning direction are disposed appropriately on grip members used for carrying out left and right steering of the vehicle.

A vehicle steering device according to the present invention comprises grip members of steering units, which are provided on both left and right front sides of a driver's seat, are gripped respectively by left and right hands of a driver, and are capable of being movably operated in forward and rearward directions of a vehicle, wherein the left and right grip members are connected so that when one of the grip members is moved rearward, the other is moved forward, and operating members adapted to indicate a right or left turning direction are arranged respectively on each of the grip members, each of the operating members is capable of being operated in both axial directions of the respective grip members, and from among respective left and right direction indicators, a direction indicator on one side is placed in an on state by one of the operating members being operated in one axial direction, and the other of the operating members being operated in an opposite direction to the one axial direction.

According to the vehicular steering device of the present invention, the operating members for indicating a change in course or a right or left turning direction are provided on the grip members of the left and right steering units, which are capable of being movably operated in forward and rearward directions of the vehicle, and the operating members are capable of being operated in both axial directions of the grip members. Therefore, even at times that the steering units are moved forward and rearward, and during steering, it is easy to operate the operating members for indicating a change in course or a right or left turning direction.

Further, while the grip members of the left and right steering units that are grasped respectively by the left and right hands are moved respectively in opposite forward and rearward directions when turning to the right and left, the operating members, which are operated by the left and right thumbs and indicate right and left turning directions, are also manipulated respectively in opposite axial directions upon making a right or left turn or the like. Therefore, the movement of the grip members of the steering units easily matches with the movement of the operating members for indicating the right and left turning directions.

In this case, a configuration is provided in which, by moving the grip member of the steering unit on the right side in a rearward direction of the vehicle, and moving the grip member of the steering unit on the left side in a forward direction of the vehicle, the vehicle turns to the right or changes course to the right side, and further, by moving the grip member of the steering unit on the left side in a rearward direction of the vehicle, and moving the grip member of the steering unit on the right side in a forward direction of the vehicle, the vehicle turns to the left or changes course to the left side.

In this manner, with the invention according to the present application, the directions of movement of the grip members of the left and right steering units are set in accordance with the directions of operation when movements of the driver's arms are linearly converted, such as when making a right or left turn with a normal round steering wheel. Therefore, it is possible to smoothly transition from a normal round type of steering wheel to the vehicle steering device according to the present invention, which is provided with the grip members of the left and right steering units.

More specifically, a configuration may be provided in which, by the operating member on the right side being operated upwardly in the axial direction of the grip member on the right side, the direction indicator for indicating a left turning direction or a change in direction to the left side is placed in an on state, and by the operating member on the left side being operated upwardly in the axial direction of the grip member on the left side, the direction indicator for indicating a right turning direction or a change in direction to the right side is placed in an on state.

In the vehicle steering device equipped with the left and right grip members according to the present invention, the movement of the right arm in a forward direction with respect to the grip member of the right side steering unit when turning in a leftward direction or steering to the left side is made to correspond with the movement of the right finger (right thumb) that performs upward movement of the operating member on the right side grip member to place the direction indicator for indicating the left turning direction or a change in direction to the left side in an on state. Therefore, in a natural operating condition, it is possible to place the left side direction indicator in an on state.

Similarly, the movement of the left arm in a forward direction with respect to the grip member of the left side steering unit when turning in a rightward direction or steering to the right side is made to correspond with the movement of the left finger (left thumb) that performs upward movement of the operating member on the left side grip member to place the direction indicator for indicating the right turning direction or a change in direction to the right side in an on state. Therefore, in a natural operating condition, it is possible to place the right side direction indicator in the on state.

Further, by the operating member on the right side being operated downwardly in the axial direction of the grip member on the right side, the direction indicator for indicating a right turning direction or a change in direction to the right side may be placed in an on state, and by the operating member on the left side being operated downwardly in the axial direction of the grip member on the left side, the direction indicator for indicating a left turning direction or a change in direction to the left side may be placed in an on state.

According to the present invention, in the vehicle steering device equipped with the left and right grip members, the movement of the right arm in a rearward direction with respect to the grip member of the right side steering unit when turning in a rightward direction or steering to the right side is made to correspond with the movement of the right finger (right thumb) that performs a downward movement of the operating member on the right side grip member to place the direction indicator for indicating the right turning direction or a change in direction to the right side in an on state. Therefore, in a natural operating condition, it is possible to place the right side direction indicator in the on state.

Similarly, the movement of the left arm in a rearward direction with respect to the grip member of the left side steering unit when turning in a leftward direction or steering to the left side is made to correspond with the movement of the left finger (left thumb) that performs downward movement of the operating member on the left side grip member to place the direction indicator for indicating the left turning direction or a change in direction to the left side in an on state. Therefore, in a natural operating condition, it is possible to place the left side direction indicator in the on state.

According to the present invention, the operating members for indicating a change in course or a right or left turning direction are provided on the grip members of the left and right steering units, which are capable of being movably operated in forward and rearward directions of the vehicle, and the operating members are capable of being operated in both axial directions of the grip members. Therefore, even at times that the steering units are moved forward and rearward, and during steering, it is easy to operate the operating members for indicating a change in course or a right or left turning direction.

Further, while the grip members of the left and right steering units that are grasped respectively by the left and right hands are moved respectively in opposite forward and rearward directions when turning to the right and left, the operating members, which are operated by the left and right thumbs and indicate right and left turning directions, are also manipulated respectively in opposite axial directions upon making a right or left turn or the like. Therefore, the movement of the grip members of the steering units easily matches with the movement of the operating members for indicating the right and left turning directions. More specifically, there is continuity between the movement of the arms during turning and the movement of the fingers of the right and left turning indicators, and thus operation of the vehicle steering device is facilitated.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a vehicle in which a vehicle steering device according to the present embodiment is incorporated;

FIG. 2 is a front view showing a typical exemplary internal configuration of a coupling mechanism that connects to left and right steering units and a steering shaft;

FIG. 3 is a front view of grip members when the vehicle is held in a state of moving straight forward;

FIG. 4 is a front view of grip members of a right steering specification according to a first modification; and

FIG. 5 is a front view of grip members of a left steering specification according to a second modification.

### DESCRIPTION OF THE PREFERRED EMBODIMENTS

A preferred embodiment of a vehicle steering device according to the present invention will be described in detail below with reference to the accompanying drawings.

### [Configuration]

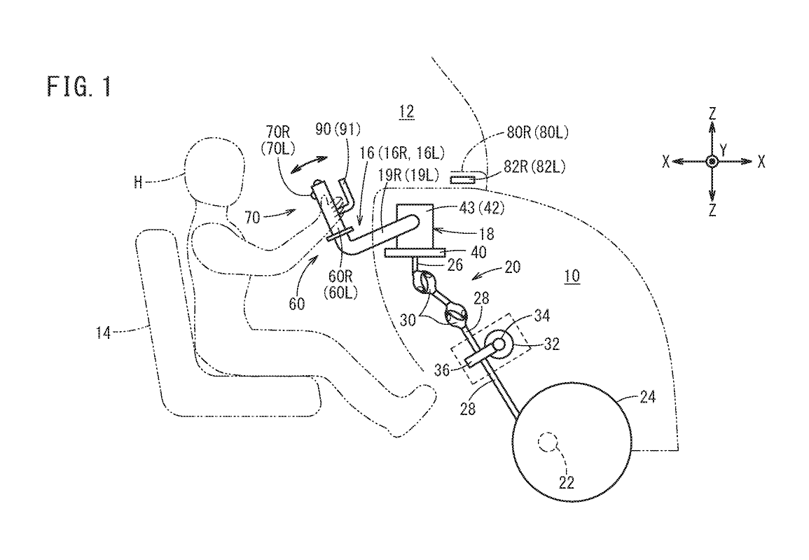

FIG. 1 is a schematic configuration diagram of a vehicle 12 in which a vehicle steering device (hereinafter also referred to as a “steering device”) 10 according to the present embodiment is incorporated.

Basically, the vehicle steering device 10 includes a pair of steering units 16 (16L, 16R) provided on the left and right in the front on both sides of a driver's seat 14, a coupling mechanism 18, a steering shaft 20, a rack shaft 22, and steered wheels 24.

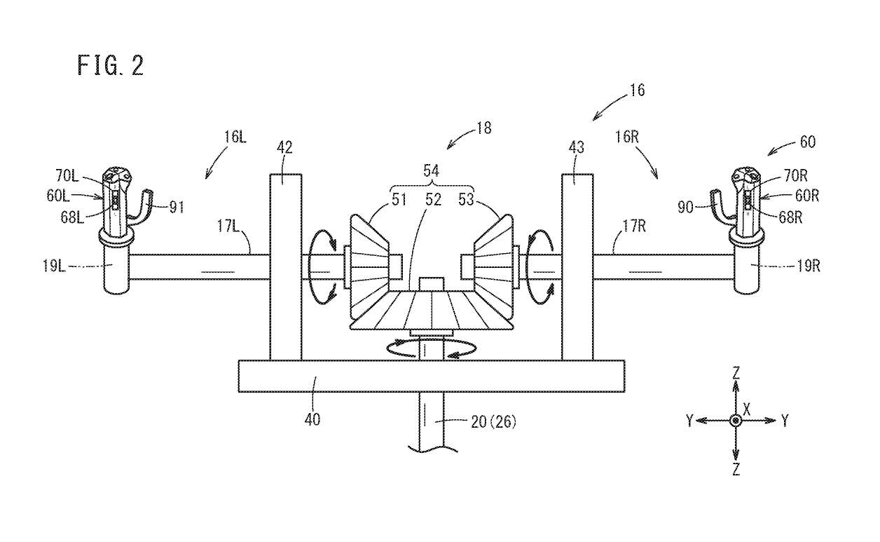

FIG. 2 is a front view showing a typical exemplary internal configuration of the coupling mechanism 18, which connects to the left and right steering units 16L, 16R and the steering shaft 20. Moreover, bearings are arranged appropriately on each of the shafts, however, for the sake of avoiding complexity and to facilitate understanding, illustration of this feature is omitted.

As shown in FIGS. 1 and 2, the steering shaft 20 is of a structure in which a main shaft 26, which is connected to the steering units 16 via a coupling mechanism 18, and a pinion shaft 28, on which a pinion gear of a non-illustrated rack and pinion mechanism is provided, are connected by two universal joints 30.

The pinion gear of the rack and pinion mechanism is enmeshed with the rack shaft 22, which is capable of being moved in a reciprocating manner in the vehicle widthwise direction Y, and the steered wheels 24 are connected via tie rods to both ends of the rack shaft 22.

The vehicle steering device 10 is equipped with a motor 32 of an electric power steering device, which applies an auxiliary steering force to the pinion shaft 28 in order to reduce the steering force by the steering units 16.

A worm gear 34, which is provided on a rotating shaft of the motor 32, is enmeshed with a worm wheel gear 36 disposed on the pinion shaft 28.

Although not described in detail because it is well known, in the electric power steering device, a speed reducing mechanism is constituted by the worm gear 34 and the worm wheel gear 36. In addition, the speed reducing mechanism smoothly converts a rotational driving force of the motor 32, which is controlled on the basis of a steering torque, a steering angle, the vehicle speed and the like, into the rotational driving force of the pinion shaft 28. Moreover, a torque sensor for detecting the steering torque is provided on the steering shaft 20, the main shaft 26, or the pinion shaft 28.

As shown in FIG. 2, the coupling mechanism 18 that connects the steering shaft 20 and the steering units 16 is constituted from a base plate 40 which rotatably supports the steering shaft 20, steering plates 42, 43 disposed on the base plate 40 and which rotatably support the left and right steering units 16L, 16R, and a gear mechanism 54 including three bevel gears 51, 52, 53.

Stated otherwise, the coupling mechanism 18 is constituted in a manner so that the left and right bevel gears 51, 53, which are fastened to the left and right steering units 16L, 16R, are connected to the bevel gear 52, which is fastened to the steering shaft 20.

The gear mechanism 54 also functions as a reversing mechanism for reversing the mutual directions of rotation of the left and right steering units 16L, 16R.

More specifically, considering a case in which the vehicle 12 is kept in a state of moving straight forward, the steering units 16 (16L, 16R) are equipped with horizontal shaft members 17L, 17R, which extend from the bevel gears 51, 53 in axial directions of the bevel gears 51, 53 and on both sides in the vehicle widthwise direction Y, side shaft members 19L, 19R on both sides (see FIG. 1), which are bent and extend obliquely downward toward the side of the driver's seat 14 from the horizontal shaft members 17L, 17R, and columnar shaped grip members (also referred to as “grips”) 60 (60L, 60R), which are bent obliquely upward from ends on the driver's seat 14 side of the side shaft members 19L, 19R and extend obliquely upward at end portions thereof.

Because the left and right grip members 60L, 60R are fastened by respectively provided screw members to the end portions, which are bent upwardly from the side shaft members 19L, 19R on both sides, handling of a so-called single-piece left grip 60L and a single-piece right grip 60R is made possible.

In FIGS. 1 and 2, the directions of three axes represented by the orthogonal arrows indicate the vehicle widthwise direction Y, the vehicle lengthwise direction X, and the vehicle height direction Z, respectively.

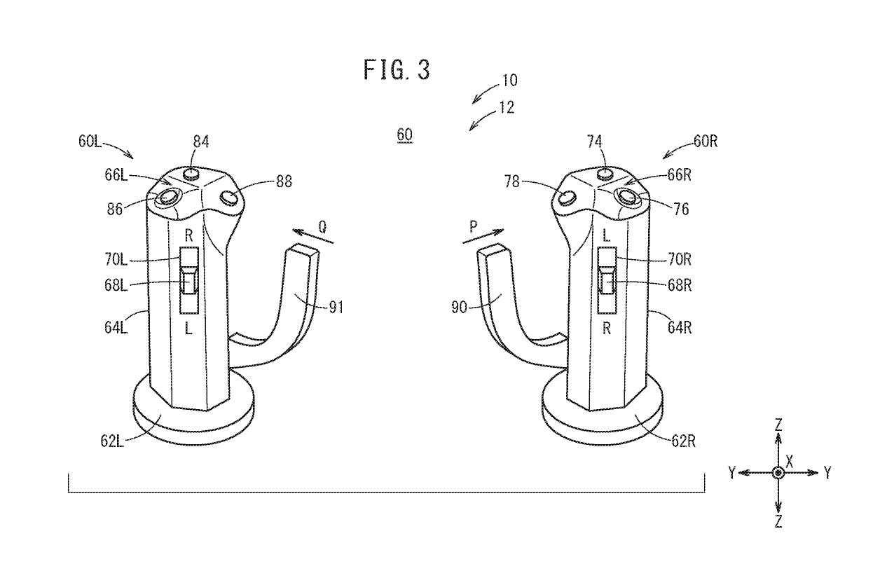

FIG. 3 is a front view of the grip members 60L, 60R when the vehicle 12 is held in a state of moving straight forward, and the steering units 16 are in a so-called normal position. In FIG. 3, the left and right grip members 60L, 60R are extracted and enlarged from the illustration thereof shown in FIG. 2.

As viewed from the perspective of a driver H who is seated in the driver's seat 14, the grip members 60L, 60R have substantially left and right symmetrical structures in terms of their external shapes.

The grip members 60L, 60R are formed in a hexagonal columnar shape as a whole. The shape thereof is not limited to being a hexagonal columnar shape, but may also be a pentagonal columnar shape, a circular columnar shape, a semicircular columnar shape having a semicircular cross section, or the like.

Flanges 62L, 62R are disposed on lower end portions of the grip members 60L, 60R. Hexagonal columnar shaped grip main body portions 64L, 64R are provided with columnar shapes (vertical shapes) on the flanges 62L, 62R. Quadrangular frustoconical portions 66L, 66R are disposed on upper end parts of the grip main body portions 64L, 64R.

Turn signal switches (direction indicating switches) 70L, 70R in the form of slide switches having knobs (buttons) 68L, 68R that slide in both directions {a roughly vehicle heightwise direction (also referred to as a vertical direction) Z} from the position shown in the drawing (referred to as a home position or a neutral position) and along the lengthwise direction of the grip members 60L, 60R are provided on side surfaces of the grip main body portions 64L, 64R that face toward the driver H. In the present embodiment, momentary switches, in which, in the case that the knobs 68L, 68R are not operated in the vertical direction with the fingers, the knobs 68L, 68R, i.e., the turn signal switches 70L, 70R, are self-restored to their neutral positions, are selected for the turn signal switches 70L, 70R. However, alternate switches may also be selected for the turn signal switches 70L, 70R.

The character “R” indicating right is displayed by way of engraving or the like at a position on the upper side (upwardly), and the character “L” indicating left is displayed by way of engraving or the like at a position on the lower side (downwardly) of the left side turn signal switch 70L.

The character “L” indicating left is displayed by way of engraving or the like at a position on the upper side (upwardly), and the character “R” indicating right is displayed by way of engraving or the like at a position on the lower side (downwardly) of the right side turn signal switch 70R. The characters “L” and “R” are configured so as to be capable of being illuminated.

It should be borne in mind that the engravings “L” and “R” are vertically inverted on the left and right grip members 60L, 60R.

On the right side turn signal switch 70R, when the knob 68R is slidably operated downwardly toward the “R” side, a right side direction indicating lamp 82R, which is disposed on the right side door mirror 80R shown in FIG. 1, flashes. Further, when the knob 68R is slidably operated upwardly toward the “L” side, a left side direction indicating lamp (designated by the symbol 82L for the sake of convenience) which is disposed on the left side door mirror not shown in FIG. 1 (designated by the symbol 80L for the sake of convenience) flashes.

On the left side turn signal switch 70L, when the knob 68L is slidably operated upwardly toward the “R” side, for example, a right side direction indicating lamp 82R, which is disposed on the right side door mirror 80R shown in FIG. 1, flashes. Further, when the knob 68R is slidably operated downwardly toward the “L” side, a left side direction indicating lamp (designated by the symbol 82L for the sake of convenience) which is disposed on the left side door mirror not shown in the figure (designated by the symbol 80L for the sake of convenience) flashes.

A push button type of horn switch (alarm device) 76 and an up-shift switch 78 are disposed on an upper surface of the quadrangular frustoconical portion 66R of the right side grip member 60R, on the right side surface and the left side surface thereof, respectively, as viewed from the perspective of the driver H. The push button switch 74 on the upper surface is a spare switch that can suitably be set to other functions, such as a hazard switch, for example.

A lever switch 90 for switching the direction in which the headlamp irradiates light, and which is restored to the illustrated home position by a spring, is further provided on a side surface portion of the right side grip main body portion 64R. By operating the lever switch 90 in the direction of the arrow P, the direction in which the headlamp irradiates light is switched from a so-called low beam direction to a high beam direction.

A push button type of horn switch (alarm device) 86 and a down-shift switch 88 are disposed on an upper surface of the quadrangular frustoconical portion 66L of the left side grip member 60L, on the right side surface and the left side surface thereof, respectively, as viewed from the perspective of the driver H. The push button switch 84 on the upper surface is a spare switch that can suitably be set to other functions, such as a hazard switch, for example.

In the case that the push button switches 74, 84 at the upper end portions of the columnar shaped left and right grip members 60L, 60R are set as hazard switches, then in a so-called right-handed vehicle, the push button switch 84 of the grip member 60L on the left side of the passenger seat preferably is set as the hazard switch, whereas in a so-called left-handed vehicle, the push button switch 74 of the grip member 60R on the right side of the passenger seat preferably is set as the hazard switch. This is because such a feature facilitates operation by the occupant in the front passenger seat in an emergency situation.

A lever switch 91 for ejecting a washer liquid, and which is restored to the illustrated home position (a standby state for ejection of the washer fluid) by a spring, is further provided on a side surface portion of the left side grip main body portion 64L. By operating the lever switch 91 in the direction of the arrow Q, the washer fluid is ejected from a non-illustrated nozzle onto the surface of the windshield.

Moreover, as shown in FIG. 3, the left and right horn switches 76, 86 are disposed inside of concave portions, thereby making it possible to suppress operation of the horn due to erroneous pressing of the horn switches.

Further, operating members having the same functions and which are provided on the left and right grip members 60L, 60R are set so that the functions of the operating member which is operated later becomes effective.

### [Operations]

Operations and operating methods of the vehicle steering device 10, which is constructed basically in the manner described above, will now be explained.

Concerning the steering unit 16, the relative positional relationship between the driver's seat 14 and the steering unit 16 is set in advance, so that in a state in which the driver H has bent the left and right elbows at a time that the vehicle is in a state of moving straight forward, the grip members 60L, 60R can be gripped by the left and right hands.

Stated otherwise, in the steering device 10, the driver H grips the grip members 60L, 60R of the steering units 16L, 16R respectively with the right and left hands, and bends and extends the left and right arms substantially forward and rearward, whereby the steering shaft 20 can be rotated, and the steered wheels 24 can be steered through the rack shaft 22 and by rotation of the steering shaft 20. In other words, the driver H can perform steering by moving the arms that have gripped the grip members 60L, 60R back and forth (substantially forward and rearward).

For example, to provide a more specific description taking as an example the case of performing a right turn or a change in direction to the right side, the driver H who is grasping the right side grip main body portion 64R with the right hand operates the knob 68R of the turn signal switch 70R downwardly (toward the side of the engraving “R”) with the right thumb, or the driver H who is grasping the left side grip main body portion 64L with the left hand operates the knob 68L of the turn signal switch 70L upwardly (toward the side of the engraving “R”) with the left thumb, whereby, for example, the direction indicating lamp 82R disposed on the right side door mirror 80R is made to flash.

Next, when the right side grip member 60R is tilted by the right arm so as to be pulled toward the front side (toward the driver's seat 14 side), and at the same time, the left side grip member 60L is tilted by the left arm so as to be pushed toward the rear side (toward the front side or the front windshield side of the vehicle 12), as viewed from the perspective of the driver H, then simultaneously with the right side horizontal shaft member 17R of the steering unit 16 being rotated in the direction of the arrow shown in FIG. 2, the left side horizontal shaft member 17L is rotated in the direction of the arrow of the opposite direction, and at the same time, the steering shaft 20 (pinion shaft 28) rotates in the direction of the arrow (rotates to the left as viewed in plan), and since the rack shaft 22 moves in a rightward direction, the steered wheels 24 are inclined in the right turning direction. At this time, the steering force is assisted by the motor 32.

Conversely, to provide a more specific description taking as an example the case of performing a left turn or a change in direction to the left side, the driver H who is grasping the left side grip main body portion 64L with the left hand operates the knob 68L of the turn signal switch 70L downwardly (toward the side of the engraving “L”) with the left thumb, or the driver H who is grasping the right side grip main body portion 64R with the right hand operates the knob 68R of the turn signal switch 70R upwardly (toward the side of the engraving “L”) with the right thumb, whereby the direction indicating lamp 82L (not shown) disposed on the left side door mirror 80L (not shown) is made to flash.

Next, when the left side grip member 60L is tilted by the left arm so as to be pulled toward the front side, and at the same time, the right side grip member 60R is tilted by the right arm so as to be pushed toward the rear side (toward the front side or the front windshield side of the vehicle 12), as viewed from the perspective of the driver H, then simultaneously with the left side horizontal shaft member 17L of the steering unit 16 being rotated in an opposite direction to that of the arrow, the right side horizontal shaft member 17R is rotated in the opposite direction to that of the arrow of the opposite direction, and at the same time, the steering shaft 20 (pinion shaft 28) rotates in the opposite direction to that of the arrow, and since the rack shaft 22 moves in a leftward direction, the steered wheels 24 are inclined in the left turning direction. At this time as well, the steering force is assisted by the motor 32.

More specifically, the driver H grips the grip members 60 (60L, 60R) of the steering unit 16 (16L, 16R) with the left and right hands, and bends and extends the left and right arms substantially forward and rearward, whereby the left and right steered wheels 24 can be steered in the left turning direction or the right turning direction.

In this manner, in the vehicle steering device 10 according to the above-described embodiment, the grip members 60 (60L, 60R) of the steering units 16 (16L, 16R), which are grasped respectively by the left and right hands of the driver H, and can be operated to move in the forward and rearward directions of the vehicle 12, are provided on both left and right front sides of the driver's seat 14, and the grip members 60 (60L, 60R) of the left and right steering units 16 (16L, 16R) are connected to each other through the coupling mechanism 18 in a manner so that when one of the grip members is moved rearward, the other is moved forward.

The turn signal switches 70 (70L, 70R) (see FIG. 3) as operating members for indicating the right or left turning direction or the like are arranged on each of the grip members 60L, 60R.

In this case, the respective turn signal switches 70L, 70R can be operated in both axial directions of the grip members 60L, 60R, and by one of the turn signal switches, for example, the turn signal switch 70L, being operated in one axial direction (for example, upwardly toward the side of the engraving “R”), and the other of the turn signal switches, in this case, the turn signal switch 70R, being operated in an opposite axial direction (in this case, downwardly toward the side of the engraving “R”), then among the left and right direction indicators (left and right direction indicating lamps 82L, 82R), the direction indicator (direction indicating lamp 82R) on one side (in this case, the right side) is placed in the on state.

In this manner, the turn signal switches 70 (70L, 70R) for indicating a change in course or a right or left turning direction are provided on the grip members 60 (60L, 60R) of the left and right steering units 16 (16L, 16R), which are capable of being movably operated in forward and rearward directions of the vehicle 12, and the turn signal switches 70 (70L, 70R) are capable of being operated in both axial directions (substantially in the vehicle height direction Z) of the grip members 60 (60L, 60R). Therefore, even at times that the grip members 60 (60L, 60R) of the steering units 16 (16L, 16R) are moved forward and rearward, and during steering, it is easy to operate the turn signal switches 70 (70L, 70R) for indicating a change in course or a right or left turning direction.

Further, while the grip members 60 (60L, 60R) of the respective left and right steering units 16 (16L, 16R) are being moved in opposite forward and rearward directions when turning to the right or left, the turn signal switches 70 (70L, 70R) for indicating right and left turning directions are also operated respectively in opposite axial directions upon turning to the right or left or the like, and therefore, are easily matched with the movements of the steering units 16 (16L, 16R).

More specifically, according to the above-described embodiment, by moving the grip member 60R of the steering unit 16R on the right side by the right arm in a rearward direction (toward the rear side in the vehicle longitudinal direction X), and moving the grip member 60L of the steering unit 16L on the left side by the left arm in a forward direction (toward the front side in the vehicle longitudinal direction X), the vehicle 12 turns to the right or changes course to the right side. On the other hand, by moving the grip member 60L of the steering unit 16L on the left side by the left arm in a rearward direction (toward the rear side in the vehicle longitudinal direction X), and moving the grip member 60R of the steering unit 16R on the right side by the right arm in a forward direction (toward the front side in the vehicle longitudinal direction X), the vehicle 12 turns to the left or changes course to the left side.

In this manner, the directions of movement of the left and right steering units 16L, 16R are set in accordance with the directions of operation when movements of the driver's arms, such as when making a right or left turn with a normal round steering wheel, are linearly converted in forward and rearward directions. Therefore, it is possible to smoothly transition from a normal round type of steering wheel to the vehicle steering device 10, which is provided with the steering units 16L, 16R equipped with the left and right grip members 60L, 60R according to the present embodiment.

More specifically, by (the knob 68R of) the turn signal switch 70R on the right side being operated upwardly (toward the side of the engraving “L”) in the axial direction of the grip member 60R, the direction indicator (left side direction indicating lamp 82L) for indicating the left turning direction or a change in direction to the left side is placed in an on state, and by (the knob 68L of) the turn signal switch 70L on the left side being operated upwardly (toward the side of the engraving “R”) in the axial direction of the grip member 60L, the direction indicator (right side direction indicating lamp 82R) for indicating the right turning direction or a change in direction to the right side is placed in an on state.

In this manner, in the vehicle steering device 10 equipped with the left and right grip members 60L, 60R, the movement of the right arm in a forward direction with respect to the grip member 60R of the right side steering unit 16R when turning in a leftward direction or steering to the left side is made to correspond with the movement of the right finger (right thumb) that performs upward movement (toward the side of the engraving “L”) with respect to (the knob 68R of) the turn signal switch 70R on the right side grip member 60R to place the direction indicator (left side direction indicating lamp 82L) for indicating the left turning direction or a change in direction to the left side in an on state. Therefore, in a natural operating condition, it is possible to place the left side direction indicator (left side direction indicating lamp 82L) in the on state.

Similarly, the movement of the left arm in a forward direction with respect to the grip member 60L of the left side steering unit 16L when turning in a rightward direction or steering to the right side is made to correspond with the movement of the left finger (left thumb) that performs upward movement (toward the side of the engraving “R”) with respect to (the knob 68L of) the turn signal switch 70L on the left side grip member 60L to place the direction indicator (right side direction indicating lamp 82R) for indicating the right turning direction or a change in direction to the right side in an on state. Therefore, in a natural operating condition, it is possible to place the right side direction indicator (right side direction indicating lamp 82R) in the on state.

Moreover, by (the knob 68R of) the turn signal switch 70R on the right side being operated downwardly (toward the side of the engraving “R”) in the axial direction of the grip member 60R, the direction indicator (right side direction indicating lamp 82R) for indicating the right turning direction or a change in direction to the right side is placed in an on state, and by (the knob 68L of) the turn signal switch 70L on the left side being operated downwardly (toward the side of the engraving “L”) in the axial direction of the grip member 60L, the direction indicator (left side direction indicating lamp 82L) for indicating the left turning direction or a change in direction to the left side is placed in the on state.

Further, in the vehicle steering device 10 equipped with the left and right grip members 60L, 60R, the movement of the right arm in a rearward direction with respect to the grip member 60R of the right side steering unit 16R when turning in a rightward direction or steering to the right side is made to correspond with the movement of the right finger (right thumb) that performs downward movement (toward the side of the engraving “R”) with respect to (the knob 68R of) the turn signal switch 70R on the right side grip member 60R to place the direction indicator (direction indicating lamp 82R) for indicating the right turning direction or a change in direction to the right side in an on state. Therefore, in a natural operating condition, it is possible to place the right side direction indicator (right side direction indicating lamp 82R) in the on state.

Similarly, the movement of the left arm in a rearward direction with respect to the grip member 60L of the left side steering unit 16L when turning in a leftward direction or steering to the left side is made to correspond with the movement of the left finger (left thumb) that performs downward movement (toward the side of the engraving “L”) with respect to (the knob 68L of) the turn signal switch 70L on the left side grip member 60L to place the direction indicator (direction indicating lamp 82L) for indicating the left turning direction or a change in direction to the left side in an on state. Therefore, in a natural operating condition, it is possible to place the left side direction indicator (left side direction indicating lamp 82L) in the on state.

### [Modification 1]

The vehicle steering device 10 of the above-described embodiment is capable of being installed with respect to either one of vehicles, from among a vehicle having a so-called right-hand steering specification (right handle specification) and a vehicle having a so-called left-hand steering specification (left handle specification).

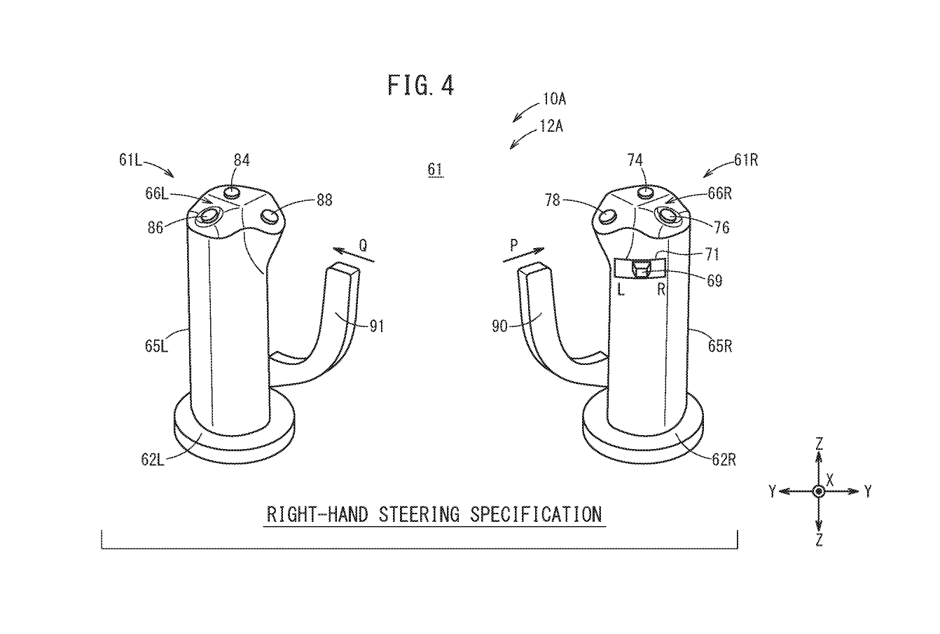

In contrast thereto, in a vehicle steering device 10A for a vehicle 12A having a right-hand steering specification of the exemplary Modification 1 shown in the front view of FIG. 4, a turn signal switch 71 made up from a slide switch as an operating member for indicating a right or left turning direction, and having a knob 69 capable of being operated in left and right directions (in the vehicle widthwise direction Y), is provided on only the main body portion 65R of the right side grip member 61R from among the left and right grip members 61L, 61R.

By moving the knob 69 in the right direction (in the direction of the engraving “R”) by the right thumb in a state in which the grip member 61R is gripped with the right hand, the right side direction indicator (direction indicating lamp 82R) can be placed in an on state. On the other hand, by moving the knob 69 in the left direction (in the direction of the engraving “L”) by the right thumb in a state in which the grip member 61R is gripped with the right hand, the left side direction indicator (direction indicating lamp 82L) can be placed in an on state.

The remaining components are the same as those of the left and right grip members 60L, 60R shown in FIG. 3, and therefore, detailed description of such features is omitted.

In the vehicle 12A equipped with the vehicle steering device 10A according to Modification 1, because an operating system such as an air conditioner or an audio device can be arranged between the driver's seat and the passenger's seat, it is appropriate for the turn signal switch 71 to be arranged on a side opposite thereto.

### [Modification 2]

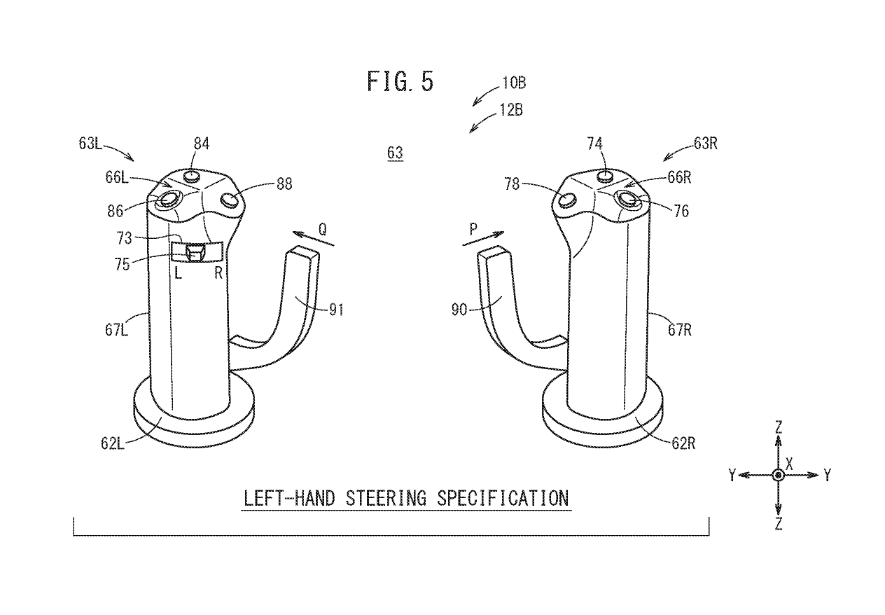

In a vehicle steering device 10B for a vehicle 12B having a left-hand steering specification of the exemplary Modification 2 shown in the front view of FIG. 5, a turn signal switch 73 made up from a slide switch as an operating member for indicating a right or left turning direction, and having a knob 75 capable of being operated in left and right directions (in the vehicle widthwise direction Y), is provided on only the main body portion 67L of the right side grip member 63L from among the left and right grip members 63L, 63R.

In this case, by moving the knob 75 in the right direction (in the direction of the engraving “R”) by the left thumb in a state in which the grip member 63L is gripped with the left hand, the right side direction indicator (direction indicating lamp 82R) can be placed in an on state. On the other hand, by moving the knob 75 in the left direction (in the direction of the engraving “L”) by the left thumb in a state in which the grip member 63L is gripped with the left hand, the left side direction indicator (direction indicating lamp 82L) can be placed in an on state.

The remaining components are the same as those of the left and right grip members 60L, 60R shown in FIG. 3, and therefore, detailed description of such features is omitted.

In the vehicle 12B equipped with the vehicle steering device 10B according to Modification 2, because an operating system such as an air conditioner or an audio device can be arranged between the driver's seat and the passenger's seat, it is appropriate for the turn signal switch 73 to be arranged on a side opposite thereto.

The present invention is not limited to the above-described embodiment, and it goes without saying that various alternative or additional configurations could be adopted therein based on the descriptive content of the present specification.

What is claimed is:

1. A vehicle steering device, comprising:
grip members of steering units, which are provided on both left and right front sides of a driver's seat, are gripped respectively by left and right hands of a driver, and are capable of being movably operated in forward and rearward directions of a vehicle;
wherein the left and right grip members are connected so that when one of the grip members is moved rearward, the other is moved forward, and operating members adapted to indicate a right or left turning direction are arranged respectively on each of the grip members;
each of the operating members is capable of being operated in both axial directions of the respective grip members; and
from among respective left and right direction indicators, a direction indicator on one side is placed in an on state by one of the operating members being operated in one axial direction and the other of the operating members being operated in an opposite direction to the one axial direction.

2. The vehicle steering device according to claim 1, wherein the left and right grip members of the left and right steering units are connected through a coupling mechanism in a manner so that when one of the grip members is moved rearward, the other is moved forward.

3. The vehicle steering device according to claim 2, wherein the coupling mechanism is of a structure in which left and right gears, which are fastened to the left and right steering units, are connected with respect to a gear that is fastened to a steering shaft.

4. The vehicle steering device according to claim 1, wherein:
by moving the grip member of the steering unit on the right side in a rearward direction of the vehicle, and moving the grip member of the steering unit on the left side in a forward direction of the vehicle, the vehicle turns to the right or changes course to the right side; and
by moving the grip member of the steering unit on the left side in a rearward direction of the vehicle, and moving the grip member of the steering unit on the right side in a forward direction of the vehicle, the vehicle turns to the left or changes course to the left side.

5. The vehicle steering device according to claim 1, wherein:
by the operating member on the right side being operated upwardly in the axial direction of the grip member on the right side, the direction indicator for indicating a left turning direction or a change in direction to the left side is placed in an on state; and
by the operating member on the left side being operated upwardly in the axial direction of the grip member on the left side, the direction indicator for indicating a right turning direction or a change in direction to the right side is placed in an on state.

6. The vehicle steering device according to claim 1, wherein:
by the operating member on the right side being operated downwardly in the axial direction of the grip member on the right side, the direction indicator for indicating a right turning direction or a change in direction to the right side is placed in an on state; and
by the operating member on the left side being operated downwardly in the axial direction of the grip member on the left side, the direction indicator for indicating a left turning direction or a change in direction to the left side is placed in an on state.

7. The vehicle steering device according to claim 1, wherein:
a character indicating right is displayed at a position above the operating member that is disposed on the grip member on the left side, and another character indicating left is displayed at a position below the operating member; and
a character indicating left is displayed at a position above the operating member that is disposed on the grip member on the right side, and another character indicating right is displayed at a position below the operating member.

8. The vehicle steering device according to claim 1, wherein a hazard switch is disposed on an upper end portion of a grip on the passenger seat side from among the left and right grip members.
